(19) United States
(12) Patent Application Publication
(10) Pub. No.: US 2003/0046661 A1
(43) Pub. Date: Mar. 6, 2003

(54) Cross vertical application software development system and method

(76) Inventors: Mark Farber, Aptos, CA (US); Richard Schramm, North Bend, WA (US); Stuart Shirai, Altadena, CA (US)

Correspondence Address: Wen Liu, LIU & LIU LLP, Suite 1100, 811 West 7th Street, Los Angeles, CA, 90017, US

(21) Appl. No.: 10/189,265

(22) Filed: Jul. 3, 2002

Related U.S. Application Data
(60) Provisional application No. 60/302,998, filed on Jul. 3, 2001.

(51) Int. Cl. G06F 9/44; G06F 7/00

(52) U.S. Cl. 717/107; 707/104.1

(57) ABSTRACT

A system and method for the development of multiple cross-vertical application software packages each pertaining to given variant industries. The system and method employ a process for discovering and identifying common business functions from a database of industries and associated existing vertical application software listings. Once discovered and identified, applied market analyses and metrics determine a specific set of target industries and associated common business functions between them for application development. A broadly functional technology platform is developed in light of identified common business functions from the target industries. Business data and business logic relating to target industries are acquired from subject matter experts and business content providers. The acquired business data and business logic from various target industries are separately integrated with the developed technology platform to create multiple refined software applications for the target industries without altering software of the technology platform by the user.

This application makes a claim of priority from U.S. Provisional Application No. 60/302,998 (attorney docket no. 1077/201), entitled “Cross Vertical Application Software Development Process”, filed Jul. 03, 2001 in the name of Schramm et. Al, which is assigned to Great Northern Enterprises LLC, the assignee of the present invention, which application is fully incorporated by reference herein.

### BACKGROUND OF THE INVENTION

1. Field of the Invention

This invention relates generally to a system and method for producing application software which is usable in, and across, specific vertical industries. More particularly this invention relates to a process for developing one or more application software programs for given vertical industries by integrating industry specific information with a broadly functional technology platform.

2. Description of Related Art

In this section, a background of currently existing application software development methods will be presented. These methods will also be established as departure points for derivation of the present invention: Cross Vertical Application Software Development (CVASD).

In general, application software packages can be developed to be broadly functional across variant industries (“horizontal” software) or narrowly tailored to meet the specific needs of a given industry sector (“vertical” software). Horizontal software applications, though useful for a specific generalized function (such as accounting, human resources, spreadsheets), require extensive customization either through customized development efforts that are specific to the customer, the use of templates, configurable application engines or individually developed user modules to be useful in vertical environments. Even given such “add-on” or enhancement technologies, most well established vertical industries involve complex processes and workflows which require a level of functionality and specificity exceeding the realm of feasible customizations for most companies (such customizations currently involve lengthy and costly development cycles or require the company to modify the way they are accustom to doing business). Within this realm of vertical software applications, end users generally must develop such highly specified applications internally, or contract for their development such that desired functional aspects particular to their business area are met. This also leads to high costs and lengthy development cycles before a useable product is produced. Even given products that purport to automate a vertical industry process, there is a significant amount of custom development required to make the product usable for a specific company.

The software publishers and developers of such vertical applications have been plagued by a number of problems to date. At the highest level, the ability to pre-determine how they will leverage their investment in development such that they can enter multiple, disparate, and distinct markets has been at best, limited to after the fact analysis, and at worst, non-existent. Furthermore, software publishers and developers have been plagued with an inability to recreate the phenomenon that occurred with generalized horizontal applications for the global market of personal computer users. That phenomenon enabled the software industry to identify and profile application “categories,” such as word processing, and spreadsheet applications. This aspect of the personal computing movement allowed competitors to focus their efforts on a specific category and work towards attaining “critical mass” market share penetration. This phenomenon of achieving high levels of market penetration in the software industry is currently limited to the area of generalized horizontal applications developed for the generalized audience of computer users, or, all users, such as word processors, spreadsheets, etc. Software publishers and developers have consistently failed to achieve critical mass in vertical markets, much less, across multiple vertical markets in a premeditated fashion using a process for identifying synergistic categories which support multiple vertical applications, with a software architecture and marketing strategy to support it. Other relevant problems and limitations of prior systems noted by the inventor in considering the need for the system and methodology of the current invention are as follows:

Typically a “good” vertical product only addresses 50-65% of a companies needs out of the box and requires further customization.

Products are rarely developed with a true focus on industry adoption, but rather, for the adoption and purchase of a specific customer, or company.

Customization development efforts involving modification of the source code and or application environment are routine, time consuming, and costly.

Most vertical applications are geared toward individual company use, rather than industry use.

Vertical application source code is not available and Application Programming Interfaces (API's) are limited.

Companies that focus on vertical markets are often under funded, with little R&D budget

A customer feedback process is typically required for identifying new application functionality.

Product updates are often infrequent, and often buggy due to lack of adequate regression testing.

Standards based architecture is the exception, not the norm. This does not mean that relevant standards are not adhered to, but rather, standards are not created to enhance the adoption and development of the application within the industry, and across industries.

Sales and Marketing efforts are often not adequate to achieve rapid penetration, or significant share.

Distribution through channels is difficult to achieve due to business experience required and low volume, high cost model.

The high cost, low volume business model of current vertical applications significantly increased the sales cycle to the point of being detrimental to the objective of achieving critical mass market acceptance.

The specificity of current vertical applications significantly reduces their overall appeal beyond a highly targeted customer set to the point of being detrimental to the objective of achieving critical mass market acceptance.

Web efforts toward vertical applications are typically very limited, and not meant to cannibalize boxed software sales, but rather, usually act as simply a marketing tool to sell and support boxed product. This trend is changing and more software publishers and developers are porting their applications to web enabled platforms, or at a minimum, allowing web access and interfaces via web browsers into their products. This does not change their focus from providing solutions for companies rather than for industries, nor does it mean they are utilizing these development efforts to identify cross vertical application opportunities in a pre-meditated fashion.

Currently existing technologies have not adequately addressed the problems involved in vertical software development as described above.

For instance, the traditional concept of “application templates,” such as those that allow a user to “tune” or customize a horizontal host application to a limited extent for a more specific industry requirement via configuration options specific to that process, fails to sufficiently enable modifications to the functionality of the host software application to the extent that it could be considered “cross vertical” (ie. readily useable in multiple vertical industries). (or even truly vertical with enough substantive business logic to qualify as a vertical application.

Additionally, the use of traditional application engines falls short in that no currently available engine forms a broad enough technology platform to enable readily useful applications to be created in widely variant industries. For example, well known Enterprise Resource Package (ERP) software, while providing certain application platforms for individual industries, must undergo lengthy, and very costly custom development processes involving source code additions or modifications, or changes to the application environment in order to be developed into applications relevant to a given company. Additionally, ERP packages typically include basic accounting functions as a core component of their base level application engine, and do not sit above horizontal applications or contain the core elements of the business process.

Furthermore, the use of modules proves inadequate as once again, wide use among vertical business customers from across variant industries is not possible without significant additional source code engineering and development efforts for each customer, if at all.

There is therefore a need for a cross vertical application software development process for producing readily usable application software packages for the given vertical industry which overcomes the shortcomings in the prior art.

### SUMMARY OF THE INVENTION

The personal computer, with its standardized operating systems, and now software applications, has significantly driven down the cost of software to users and paved the way for defacto standards to emerge within software application categories. The cross vertical application development process of the current invention overcomes the restrictions and limitations of the prior art, and will extend this generalization of computing requirements to the universe of business applications with many, if not all, the same business impacts. In short, this invention has the potential to drastically change the model for developing vertical application software by segmenting the industry specific nomenclature from the common elements of the task. While there are many metrics and supporting elements of achieving this result, the invention is targeted at overcoming the long standing, and critical problem of software publishers and developers of achieving critical mass both within the customer sets they have targeted, the industries they are found in, and more importantly, across vertical customer sets and industries.

The present invention is directed to a software development framework and process for enabling the development of a technology platform suited to a wide scope of vertical industries, which may be coupled with “business rules” (corresponding to a specific industry) to produce highly refined software applications which are readily useable (i.e. no additional source code modifications or changes to the application environment provided are necessary). The conceptual architecture for the technology platform is that they are built in light of discovered commonalities (based on statistical market research, qualified market assumptions knowledge bases, customer feedback data and extrapolation from acquired intellectual property) from across variant industries. Business rules are acquired which correspond to intricate and unique idiosyncrasies related to a specific vertical business (such as real estate development, or motion picture development) and then integrated with the developed technology platform to produce a software application.

This invention goes beyond a traditional “application engine” model as is common in certain software (i.e. business rules builders/generators and editors) by providing a process for creating a widely usable technology platform, and then easily, with the input of specific business rules or business data, shaping the technology platform into a highly usable software application for a given industry without the need for source code or application environment modifications. Traditional application engines (e.g. ILOG software) require significant software engineering modifications to be applicable for variant industries (such as the real estate and movie production industries).

One goal of this present invention is to provide a methodology that allows a software company to identify what used to be considered a vertical line of business processes, and break them into generalized categories of business applications. Once this initial segmentation has been accomplished, a broadly functional technology platform suited to identified categories of business applications can be designed, which when integrated with industry specific business rules constitute a highly refined product for release in a specific industry.

In another embodiment of the present invention, the technology platforms themselves are licensed or sold without the addition of business rules.

In another aspect of the present invention, a methodology which allows software developers to validate strategic and market assumptions via statistically relevant market research, design and develop cross industry technology platforms, and which allow for separation of industry specific business rules from common business rules contained in the cross vertical technology platform is provided. This paradigm shift in the approach to developing and distributing technology redefines and eliminates the challenges to providing flexible pricing models, eliminating the issue of the distribution channel, raises the marketing focus from company specific to industry specific, and ultimately, redefines the manner in which vertical, or, cross vertical software is sold.

In one aspect of the present invention, a process is disclosed for creating a database of industries, market statistics, and business processes that are in use across industries.

In another aspect of the present invention, various methods are disclosed to matrix market and process data, and identify cross vertical processes that are ripe for automation and potentially lucrative areas of development.

In a further aspect of the present invention, highly refined business data and business logic is licensed from “Business Content Providers” (BCP) and/or “Subject Matter Experts” (SME) such that relevant data for layering on developed technology platforms will result in readily useable business applications.

In yet another aspect of the present invention, a relational database is provided for storing industry data, market statistics, and a catalogue of business processes and business logic such that typical sorting, mapping, and analytical functions may be performed.

In still another aspect of the present invention, the inventive system is implemented using a technology platform which is based on commonalities discovered in analyzing the relational database of the current invention. One or more platforms may be necessary to cover a chosen industry cross section given the range of business functions discovered in analyzing the relational database.

In an alternate embodiment of the current invention, rather than implementing a technology platform to exploit discovered commonalities from analysis of the relational database, potential development partners or technology licensees are identified from portions of the database using a metric based goodness of fit assessment of potential competitors, market share, and risk vs. reward propositions.

In still another aspect of the current invention, various application-programming interfaces (API's) are provided to enhance end user functionality with specific vertical software packages.

In another embodiment of the present invention, API's that enable a billing functionality are included in the technology platforms to enable collection of product usage statistics, royalties due, and facilitate tracking of other key metrics as required in a secure, automated manner.

In a further aspect of the present invention, a user interface is provided for enabling simple operation of the vertical software applications.

In another embodiment of present invention, artificial intelligence functions are included which allows end users to shape the particular vertical software application being used to include additional business logic such as elements specific to a given project, or, to add data elements for data analysis and reporting.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is a high level block diagram showing the overall vertical application software development system of the current invention.

FIG. 2 is a schematic block diagram showing the process steps according to the current invention.

FIG. 3 is a schematic block diagram illustrating the process architecture and flow in a non-linear model.

FIG. 4 is a block diagram illustrating a macro architecture showing system elements of the current invention.

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

All publications referenced herein are fully incorporated by reference as if fully set forth herein.

The present invention can find utility in a variety of implementations without departing from the scope and spirit of the invention, as will be apparent from an understanding of the principles that underlie the invention. It is understood that the cross-vertical application development concept of the present invention may be applied to vertical industries in business, entertainment, services, education, research, etc. It is also understood that while the present invention is best explained in reference to a particular set of user applications which are developed using the process, the number of particular applications made possible by this system is virtually limitless. In general for a given application, business logic and industry specific business rules may be input into the system development framework such that a readily usable application software program is generated for use.

Overall Development System

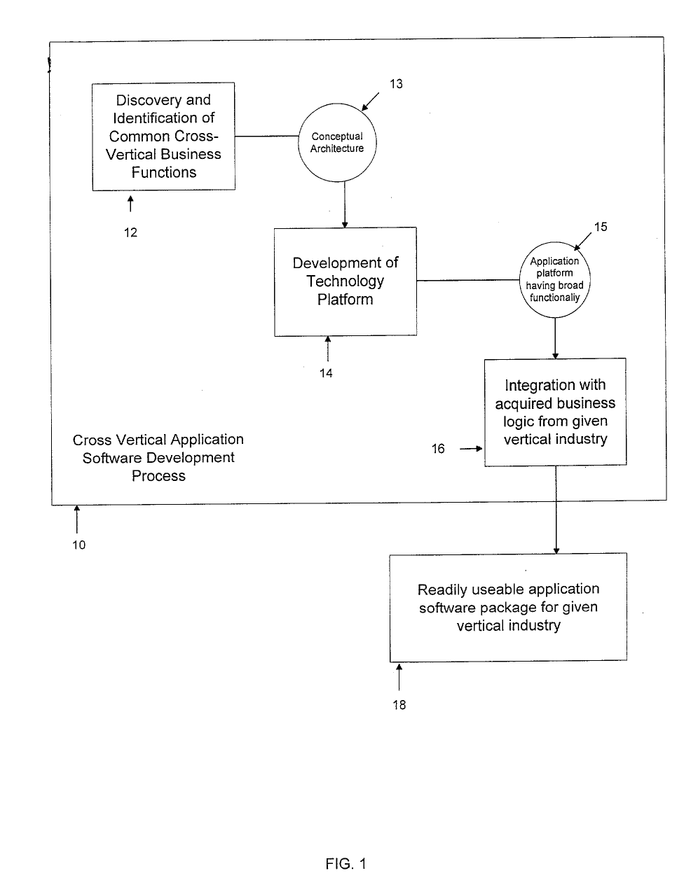

Looking now to FIG. 1, the CVASD system 10 is shown producing readily usable application software package 18 according to the current invention. Three main process elements are shown which comprise the general steps of the current development system. Initially, common functional business elements from across variant vertical industries are discovered and identified 12. From these discovered and identified common business functions, a conceptual architecture 13 for the development of a technology platform may be generated. It will be understood by those skilled in the art that, while helpful in guiding and streamlining the platform development process, conceptual architectures are not necessary to practice and use the current invention. It is entirely within the applicable scope of this invention to develop a technology platform “in light of” discovered and identified common business functionalities without reference to a prepared specification. Once the technology platform has been developed 14, a broadly functional application platform 15 is available either to sell or license as an end product itself, or preferably to integrate with acquired business logic 16 to produce readily useable software packages 18. It is generally the case that for a particular desired application software package (ie. for a specified vertical market/industry) to be generated using the developed technology platform, business logic and/or business data should be acquired from BCP's or SME's within the specified vertical market. Because the technology platform has been developed from discovered business functions relevant to the industry a particular application is generated for, users in that industry will be able to customize the application to fit specific needs without modifying source code of the application or underlying technology platform (i.e. no compilation or recompilation of the software application would be needed before use with the new user customizations).

Process Steps

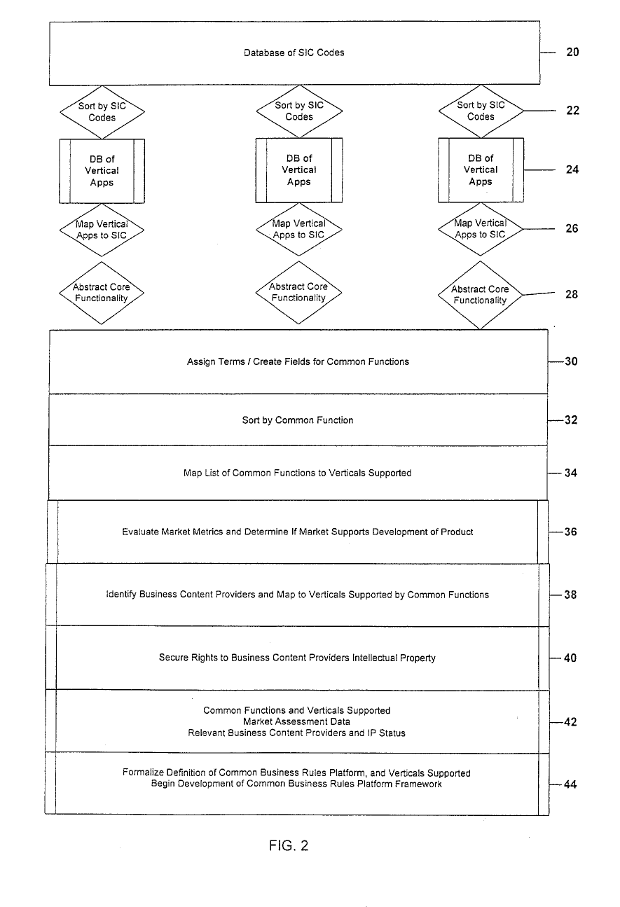

One element of the current inventions ability to generate multiple vertical application software packages without individually designing each one is the discovery and identification of common business functions from across variant and disparate vertical industries before developing a technology platform. Looking now to FIG. 2, a block process flow diagram is shown to illustrate the process by which the CVASD process may be defined as well as which vertical industries would be supported by such platform. In order to determine which vertical applications have common elements that can span across multiple industries, key data points must be collected, analyzed and run through a series of matrixes. There are numerous ways that business functions and industries are segmented. The two most common, and most basic forms of categorizing businesses and business functions are simply identifying the industry the business function falls within and correlating it with the relevant SIC/NAICS codes for each industry. An operative concept in this discovery process is the use of far greater granular analysis techniques than prior approaches in order to ferret out the elements of the business processes that are common across industries.

In step 20 of FIG. 2, a database of industry specific codes is acquired. A listing of all industries currently identified as providing “for profit” goods or services is secured such as the commercially available listing from North American Industry Classification System (NAICS) and/or the Standard Industrial Classification (SIC) available from the Occupational Safety and Health Administration (OSHA). In step 22, the various industries to be examined according to this current invention are sorted by SIC codes In step 24 a database of known vertical applications is compiled. Lists of vertical software packages (e.g. banking applications, healthcare applications, etc) may be obtained commercially through vendors of specific hardware platforms (ie. SUN Microsystems, IBM, and Hewlett Packard), published books and volumes, or through research organizations (ie. Gartener Group, Forrester Research, etc.) In the preferred embodiment, lists of vertical software packages are obtained via several different sources as illustrated by the multiple columns of functional data sets 21 in FIG. 2. Step 26 requires the mapping of vertical application data in the database to SIC codes also in the database such that each package is related to the appropriate industry for which it contains key functionality. In step 28, core functional elements are abstracted from the relational database. For example, in examining the healthcare industry, one could easily determine, or abstract, that much of what is done in the industry is comprised of three basic elements; Collect Data, Analyze Data and Report Data. These descriptors would be used in empty fields of the database as keys to sort by. In so doing, a list of applications in industries, and in sic codes may be created that utilize the same key elements, and thus help to identify a cross vertical application category.

Optionally before step 26, given the relative complexity of performing granular analysis on such an immense database, it may be desirable to perform market research (size of various markets identified) as a means to fine tune predictability of discovering common business rules as well as glean the most potentially lucrative development opportunities. An additional optional step is to identify the market share of vertical applications within a given market realm as a means to further fine tune subsequent analysis of the relational database. It will be understood and appreciated by those skilled in the art that numerous other decision aiding metrics may be employed to reduce the potential scope of database analysis and increase the significance and relevance of discovered common business rules.

In step 30, all of the data obtained in steps 20-30 is imported into a relational database. The purpose of this step is to identify trends and matrix the various data points such that meaningful data can be derived. The database is preferably a SQL database, but can be any relational database in which a collection of data items can be organized as a set of formally described tables from which data can be accessed or reassembled in many different ways without having to reorganize the database tables. Those skilled in the art will understand and appreciate the flexibility of various database applications as applied to the current invention, and appropriately design a relational database to perform the functionality described herein. In addition to the fields created by the import in this step, at least four blank fields, defined as keys for sorting purposes, should be added to the data base for assigning tags that help to describe the industry process automated, the workflow, and other items of importance to the software publisher or developer. These fields are not pre-defined, as it will likely be the case that each software publisher or developer will establish their own terms and means of classifying the data under review.

In step 32, the list of vertical applications is manually traversed and descriptors are assigned that identify the characteristics of the application. These descriptors could be very basic, or more specific depending on the desired level of analysis. For example, the software publisher or developer may focus on the workflow of each vertical application, and the key elements of the specific workflow. An example would be: (a) Collect data (data collection could be done via a scientific instrument, manually, or in a semi automated fashion.); (b) Analyze data (analysis of data could currently be done in using numerous well know data extraction or abstraction methods such as searching for predefined trends, or a mixture of predefined trends and ad hoc analysis.); (c) Report data (reporting of the data, to provide a summary of the key findings can be done manually, using technology that captures the key data elements and prints out a form, or in a semi-automatic fashion, with some elements automated and some manual). It is these definitions that will be used to identify similarities between one industry processes and another. If the same elements are found in two or more different industries, then the software publisher or developer should examine them more closely to determine if the process identified is a true cross vertical application.

In step 34, a mapped list of common functions to vertical applications supported is developed. Once the software publisher or developer has identified a true cross vertical business process, or, one whose core elements are found in, and are applicable across, multiple industries, the software publisher or developer must identify terminology that describes the cross vertical process identified. This terminology forms the basis for identifying the application “category.” An example of a category might be “Project Risk Management”, with examples of industries that utilize the workflow defined in this category being Real Estate Development, and Motion Picture Production. Traditionally applications for these areas have been developed specifically for each industry, with little or no ability to reuse them, much less plan to develop a cross vertical application platform that could be used to support products in each industry.

In Step 36, an evaluation of market metrics and determination if market support exists for product development is performed. Here, the software developer may identify the size of the discovered industries. This can be done on an as needed basis or, to more finely tune the predictability of identifying cross vertical application opportunities, one should do this for the complete index of industries. This step is optional, but recommended. It is understood that if a software publisher or developer were to identify cross vertical applications, they would at some point apply their own metrics for determining the viability of producing the cross vertical platform and resulting applications, and this is recommended only to provide basic market metrics. It will be understood and appreciated by those skilled in the art that each software publisher or developer will have their own criteria for determining viability of development efforts based on their respective business needs and orientation.

In step 38 BCP's and SME's for desired vertical industries are identified and mapped to vertical applications supported by common functions. If the software publisher or developer determines that the opportunity provided by the cross vertical application maps to their business requirements, a source that can provide the industry specific business logic required to augment the cross vertical application is determined. The combination of the cross vertical application platform and the industry specific business logic provides the software publisher or developer with an application that can be sold into a vertical market space. This step can be accomplished by acquiring an existing application being provided to the industry, or by identifying SME's that have automated the business process for their industry using generalized applications like spreadsheets, databases, etc. It would also be possible to partner with a SME to have them draft a requirements study, and or write the business rules based on the SME's domain expertise. Additionally, it is desirable but not necessary, that the SME should have extensive industry contacts so that they can help sell the software publisher or developers product to existing contacts in the industry.

In step 40, rights are properly secured to BCP's intellectual property assets. After step 38 has been successfully completed and a relevant SME and/or BCP identified, acquisition or licensing of the relevant intellectual property from selected SME is performed. It is preferable to acquire the intellectual property, optionally granting the SME a limited right to use if necessary. Additionally, the software manufacturer or developer should contemplate engaging the SME in a separate services agreement for ongoing support and development. That agreement should insure that all intellectual property developed under the agreement is covered by the same terms as the intellectual property agreement.

In Step 42 a master list is created and then sorted by common functions and vertical applications supported, market data and analysis, and relevant SME's and intellectual property available. The sorting can be performed to show largest potential application markets, to show vertical industries having the largest number of software packages available, or even the fewest numbers of packages available. With various sorting functions, different metrics may be applied in order to determine CVASD viability in a given industry. For instance, a developer may decide to only enter a given vertical market if less than three vertical applications currently exist for that market. It is understood and appreciated by those skilled in the art that the metrics used in this step will be business decisions made by the each developer according to their business requirements and interests.

In step 44 a formalized definition of the identified common business functions and vertical applications supported is generated. This step is optionally performed prior to development of a technology platform, and the formal definition may be in the form of a basis for a conceptual architecture for development of the technology platform. In order to generate the formalized definition, once the software publisher or developer has identified a cross vertical application category, and examples of multiple industries that utilize the process, they must make initial determinations on how to segregate the industry specific logic from the horizontal processes. In other words, which elements of the process are industry specific, and which elements are truly common between them.

It should be noted that one could identify a pattern of activities similar to the Healthcare example from step 28 above which together form a business process, or workflow that appears to be cross vertical yet does not meet the bar of being a true cross vertical application. For instance, a business process that automates the payment process between a medical practice, or hospital and the insurance company is not a true cross vertical application simply because one participant in the workflow is in the Healthcare industry and the other is in the Insurance industry. That would best be categorized as a traditional automation of a given workflow that allows the participation of two business partners in separate industries. Typically this type of application, if commercialized, would be focused on, customized for, and marketed to only one of the participants. The application would not be core to the other partners business, and while it may provide certain efficiencies, the primary partner would stand to gain the most from using it. To qualify as a true cross vertical application, the cross vertical application must be able to support business logic for multiple industries typically thought of as vertical.

Process Flow and Architecture

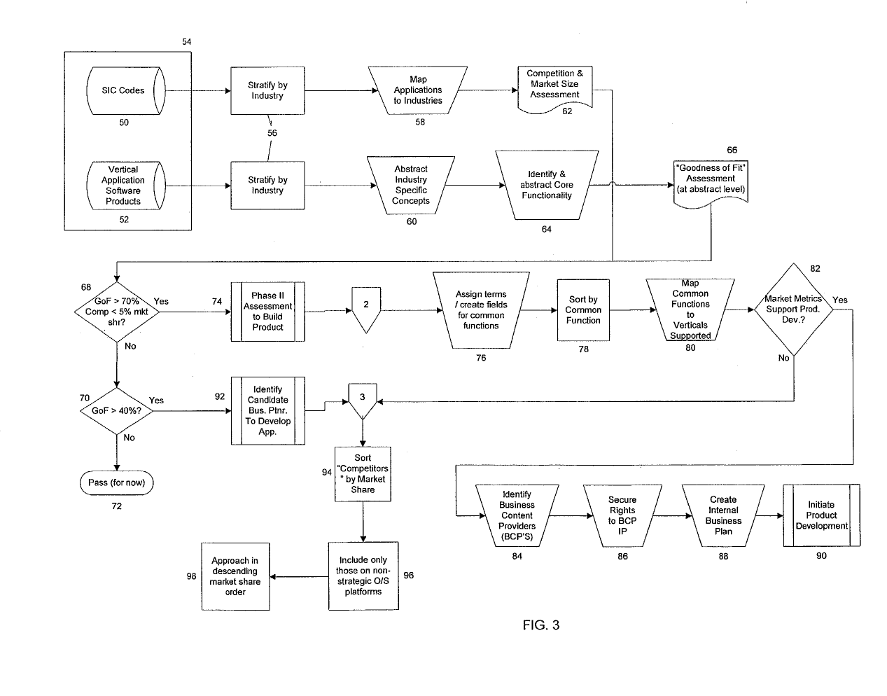

FIG. 3 illustrates the process flow and architecture of the CVASD process of the current invention, and can be seen as elaborating on the steps discussed above for FIG. 2 as well as providing an alternate embodiment in part. Initially, a database of SIC and/or NAICS Codes 50 is acquired. NAICS will be superceding SIC, but at the present time both are used in the preferred embodiment to assure completeness of industry coverage. Likewise, a Database of Vertical Application Software Products 52 is acquired in order to form relational groups with database 50. Both database 50 and 52 are contained in relational Data Base Management System (DBMS) 54 which in the preferred embodiment is a Microsoft SQL Server. It will be understood by those skilled in the art that any SQL-compliant relational DBMS will be able to accomplish the functions required by the current invention. The data itself forming database 50 and 52 can even be delivered in an electronic medium as simple as comma delimited text format and we will be able to import it into a SQL-compliant DBMS. MS-SQL Server is selected due to a combination of price & ubiquity. Once contained in DBMS 54, both database 50 and database 52 are stratified by industry in a stratify by industry process 56. There is an extremely high probability that SIC/NAICS codes will fall into groups with common attributes. For example, both Custom Computer Programming Services (NAICS=541511) and Software Publishers (NAICS=51121) produce computer software as a principal revenue generating activity. The Stratify by Industry process will assure that the codes are grouped together based on attributes which are of interest to the CVASD process rather than an arbitrary assignment of codes to industry names. Similarly application software products will fall into categories. To aggregate sales of products within a category (one possible measure of market size) individual products will have to be correlated to the industry(ies) they are designed to serve.

In the map applications to industries function 58, software applications (or major components thereof (e.g. Bill of Material Processor (BOMP) from a manufacturing system)) are manually mapped to individual or groups of the SIC/NAICS codes. For example, a BOMP could be used by both process and discrete manufacturers. In order to discover and identify common business functions across vertical industries, industry specific concepts are abstracted from database 52 in an Abstract Industry Specific Concepts process 60. In most industries the general purpose (or abstract) of a specific application is so intuitively obvious that practitioners within an industry cannot properly articulate an abstract definition of the application. For instance, a manufacturing manager would likely provide a BOMP description within a specific manufacturing context. For purposes of abstraction according to the current invention, an example BOMP description would be:

“A hierarchical relationship of raw materials, sub-assemblies and finished goods.

Variable ratios of raw materials or sub-assemblies to different finished good is required. Some variability (e.g. color) of raw materials or sub-assemblies within a finished good is desired.

The abstracted description can now be equally well applied to both manufacturing, and restaurant (i.e. recipes) SIC/NAICS codes. In functional block 62, a competition & market size assessment is completed. This can include a report which utilizes the information-developed above, or may be acquired as a separate dataset from any number of research organizations. Functional block 64 is a process to identify & abstract core functionality from the previously abstracted industry specific concepts. The process involves an evaluation of potentially competitive products and correlation of product functions with abstracts previously created. It may be necessary to create new abstractions as in block 60 to adequately abstract relevant core functionalities. For example, in examining the healthcare industry, one could easily determine, or abstract, that much of what is done in the industry is comprised of three basic elements; Collect Data, Analyze Data and Report Data. These descriptors would be used in empty fields of the database as keys to sort by. In so doing, a list of applications in industries, and in sic codes may be created that utilize the same key elements, and thus help to identify a cross vertical application category.

In block 66, a Goodness of Fit (GoF) assessment (at an abstract level) is performed. This assessment is a report which compares the core functionality of potentially competitive products with the functionality of the then current version of the Cross Vertical Application

At this stage in the system, a series of decision are made in order to determine if data and information generated in 50-66 above warrants additional development efforts according to the CVASD process. At decision point 68, if the GoF from the previous step exceeds 70% and no single competitor has more than 5% market share, then a more detailed assessment should be preformed preparatory to entering the market space. The actual percentages presented herein are for example purposes only, and it will be appreciated by those skilled in the art that different requirements may exists for software developers and publishers based on their specific risk vs. reward metrics. If a decision to proceed with development has been declined at decision point 68, decision point 70 is engaged. If the GoF is between 41% & 70%, a list of candidate companies is generated to approach who would (re-) develop their product on the CBRP. This step can be accomplished by a simple sort function on companies that fall within industry and or sic NASCI and a given market sharemarket share. If the GoF is 40% or less (this threshold may be determined differently by different software developers), development is pass on (for now) 72. The decisions above are iterative. As functionality is added to the CBRP, the GoF measurement will change relative to various industries previously evaluated.

If an initial determination at decision point 68 is positive, Phase II (74) which is an assessment to build product is performed. This is a process unto itself and is described below. In box 76, terms are assigned and fields created for common functions. Industry specific language is correlated to the abstracts derived in 60 and 64 above. Fields are then sorted by common function 78. Such sorting function are routine in the field of database analysis. In box 80, common functions from 78 are mapped to verticals supported. This step correlates functions automated by the CVASD process (described in the abstract) to functions required by a specific industry. At decision point 82, various market metrics (such as risk vs. reward propositions, cost, product viability, etc) are evaluated to determine if product development should continue. It will be understood and appreciated by those skilled in the art that many different market metrics may be evaluated in determining decision point 82 without departing from the spirit and scope of the current invention. If a decision to move forward is made, business content providers (BCP) are then identified 84. BCP are those individuals or organizations with key information and expert data relating to the specific vertical industry being targeted by the current product development effort. Once BCP are identified, right to the intellectual property assets of such BCP's are secured 86. Before actual product development begins, a software development may create and internal business plan as a roadmap for product development. This step is not essential in order to initiate product development, but is highly desirable in order to ensure that product development proceeds according to a predetermined plan. At this point, actual product development is initiated 90.

Going back to decision point 70, if a decision to proceed is made, candidates for business partnership are identified 92 to develop an application. In box 94, competitors are sorted my market share. Potential competitors identified in earlier process steps are sorted by descending size of market share so the biggest potential competitors head the list. In box 96, only those competitors on non-strategic operating system (O/S) platforms are included in the list from 94. In identifying the largest software companies in a specific market, it is assumed that such companies will have the greatest intellectual property in the market space, which is often a prohibitive factor in development. For example, to facilitate the “sale” of the cross-vertical technology platform, vendors whose products do not run on the Microsoft Windows platforms (e.g. AS/400, UNIX, etc.) would be approached first in step 98.

Technology Platform/Framework

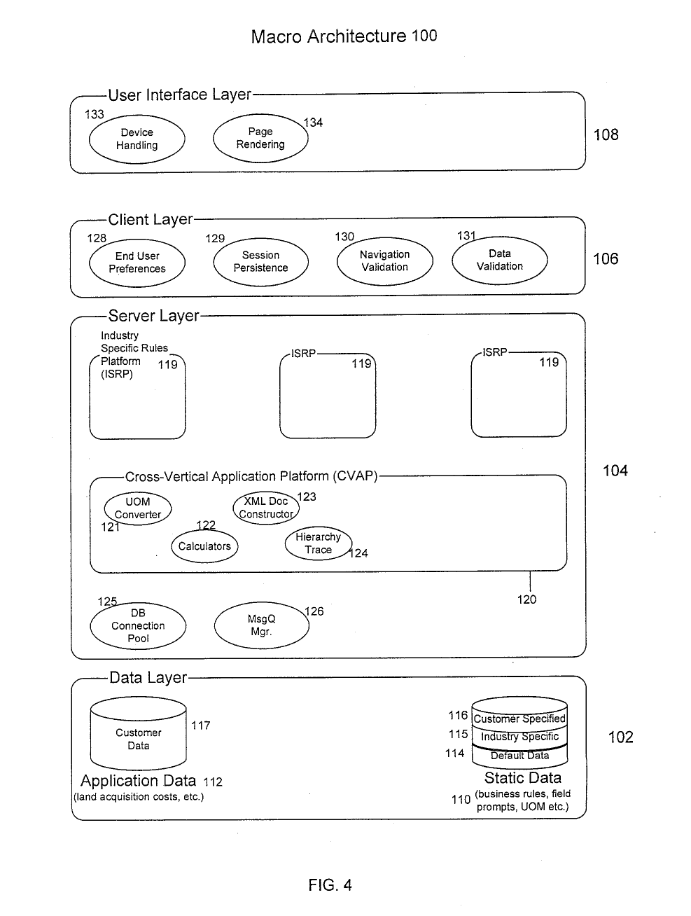

The system and method of current invention can be embodied in a computer or microprocessor. In the preferred embodiment, a computer server contains the technology platform and associated data elements for processing, analytical function, and running software code of the current invention. Looking now to FIG. 4, various layers of the technology platform are shown in macro architecture 100 according to one embodiment of the current invention. Macro architecture 100, comprising User Interface layer 108, Client layer 106, Server layer 104, and Data layer 102, is what is classically thought of as a “server” in a 4-tier architecture. As such, all 4 layers of the application can run on a single server according to the present embodiment of the current invention. It will be known and appreciated by those skilled in the art that many server architectures could be designed to support the functionality described below without departing from the spirit and scope of the current invention.

Data layer 102 contains a Data Base Management System (DBMS) and databases required by the CVASD process and industry-specific extensions. Two categories of data are housed in data layer 102: Static Data 110, and Application Data 112. Concerning Static Data 110, each level in this data store (Default data 114, Industry Specific data 115, and Customer Specified data 116) allows additional tailoring of the CVASD Process to industry or company specific lexicon without the need for reprogramming. The Default data 114 level will provide the basic templates and the ability to reset to this level should the need arise. The industry data 115 and customer data 116 specificity can be achieved by stripping away the text tags and terms that make the product “industry specific” and replacing them with the terms from another industry with little to no change to the platform itself. Application Data 112 contains customer data 117 which is entered by a given user during operation of the particular application being used.

Server layer 104 contains software components accessible to multiple users which are transactional in nature. Software components in the server layer will typically be active for the duration of a transaction, but, process a large number of them in sequence. The Industry-Specific Rules Platforms (ISRP) 119 house industry specific instances of a business rule or business function. Each platform 119 is created when a business rule/function unique to a specific industry, and distinguishable from an already existing business rule in the CVASD Process, is identified. It is anticipated that these additional rules will require additional data elements which the relational database of the CVASD process cannot manage. The ISRP is incorporated into the design to process these additional data elements. Server layer 104 additionally contains Cross Vertical Application Platform (CVAP) 120. CVAP 120, contains UOM Converter 121, which converts a quantity from one unit of measure (UOM) to another (e.g. inches to feet), Calculators 122 which are standard computer based calculation functions, XML Document Constructor 123 creates XML data streams (or documents), and Hierarchy Trace 124, which provides the functionality to move from bottom to top or top to bottom in the hierarchy (much of the data stored by CVAP is hierarchical in nature (e.g. charts of accounts, etc.)). Hierarchy Trace 124 is also used in performing standard roll-up or push-down functions. Some examples of standard functions contained within the server layer include DB Connection Pooling 125 and MsgQ Mgr. 126 which are well known server layer database functions.

The client layer 106 will contain components which are unique to a single user's interaction with the system. Examples of functions within the client layer include:

End User Preferences 128: It is assumed that at some point personalization to an individual level will be desirable. This function will “marry” data stored on end-user preferences with the page rendering functionality.

Session Persistence 129: By its very nature the web is an asynchronous network where connections from user to data is not held for the duration of a transaction. Session Persistence functionality allows users to return to a specific point in a transaction without reentering all the data previously entered.

Navigation Validation 130: Due to the disconnected nature of web applications and the ability of browsers to interrupt a planned work flow (through the use of favorites or “back buttons,” navigation from screen to screen within a web application should be validated to assure data integrity.

Data Validation 131: Which is a well known client layer data function.

The user interface (UT) layer 108 contains logic necessary to accept input and display output to various user devices (e.g. cellular-connected PDA's, cell phones, desktop or laptop PC's).

Examples of functions within the user interface layer include:

Device Handling 133: Logic specific to different devices is handled here. Rendering to WAP-enabled phones v. wireless PDA's v. desktop PC's will have to be handled differently. If vendor provided drivers exist, they will be used, however, the architecture cannot rely on vendor provided solutions exclusively.

Page Rendering 134: Which is well known functionality provided by Microsoft Corporations Internet Information Server (ITS)

According to one aspect of the present invention, the UI of the current invention is provided for user interaction with the application software package. In one embodiment of the present invention, users are allowed to modify data fields for their particular industry to customize the application. This customization can be accomplished according to the current invention without user modification of source code or recompilation of the technology platform or application. An additional artificial intelligence (AI) module in the technology platform is used to create functionality which, provide an overview of each category of a given application specific to the vertical(s) and allows the user to “shape” their project by selecting the areas they will be working on. For instance, the AI functionality at the highest level would ask the user what type of project they are planning to complete. For instance, in a land development application, a user may be asked to select between “Planned Community” or “Communities Facilities District.” Once the user selects “Planned Community” or, “Communities Facilities District” this would automatically provide the items relevant to those areas, while leaving out those for “City Planning” for example. This would continue as the user works their way down the project category “tree”. If the user opts not to select a category that, based on an earlier selection, the AI believes is part of what they should be costing, Alert Screens would pop up asking the user about this, with a tie back to the category that believes it should be included, identifying the reasons the products logic has for including it, and then, if the user still opts out, approval notices would be sent to management as identified in the set up of the program. This provides for maximum flexibility in shaping the project costing items to the customers requirements while adding accountability when the user overrides the products “recommendations” via the AI.

The AI interface will know when a particular line item consists of a series of calculations, and will provide a series of “pop up calculators” to walk the user through identifying a proper cost for the line item. This is critical in Land Acquisition where there are series of calculations required to identify the line items required in the Land Acquisition module.

In an alternate embodiment of the present invention, a billing functionality is provided as an embedded element of the technology platform. The billing element comprises a set of API's and a software module(s) that, in conjunction with a server based identification (e.g. VeriSign) application and client based Digital Certificates, will allow a software developer to collect usage statistics from the product, calculate royalties due, and provide for regular and secure communication from each installation of cross vertical application software containing a billing module. The data collected from client systems would be encrypted when sent, and decrypted by the software developer to be entered automatically into an accounting or other finance management system, which would then create the invoice and generate a billing for the client. The entirety of the collection, transmission, and invoice generation described above is preferably completed electronically, such that little or no human intervention is needed.

The billing module technology of this current embodiment and associated API's could be licensed separately to other companies as an alternate/additional revenue source to the CVAS packages of the current invention. It will be understood and appreciated by those skilled in the art that many different technical approaches and methods exist for the generation of billing modules and API's as described above.

System API's

According to one aspect of the present invention, API's, which could include XML or COM for example, will be used to provide an interface between the Cross Vertical Application and other software systems such as accounting programs, and general purpose, horizontal applications such as word processors, spreadsheets, project management tools etc. API's could also be used to create a middleware layer that provides for interfaces between one Cross Vertical Application and another. Additionally, API's could be used to provide an interface between the Cross Vertical Application and the Industry Specific Business Rules such that a programmatic means for incorporating business logic into the Cross Vertical Application's framework could be automated.

The process and system of the present invention has been described above in terms of functional modules in block diagram format. It is understood that unless otherwise stated to the contrary herein, one or more functions may be integrated in a single physical device or a software module in a software product, or one or more functions may be implemented in separate physical devices or software modules at a single location or distributed over a network, without departing from the scope and spirit of the present invention.

It is appreciated that detailed discussion of the actual implementation of each module is not necessary for an enabling understanding of the invention. The actual implementation is well within the routine skill of a programmer and system engineer, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

We claim:

1. A method for creating customized application software specific to a given industry, said method comprising the steps of:
identifying common business functions applicable to a plurality of industries, including said given industry;
developing a software based technology platform including said common business functions;
inputting data to the technology platform, said data including business rules specific to said given industry;
wherein said technology platform is structured and configured to receive said data and integrate said data with the technology platform in a manner to transform the technology platform and said data into a customized application software for said given industry without altering software of said technology platform by a user.

2. A method as in claim 1, wherein the plurality of industries are characterized by at least one of the following:
functionally distinct;
different purpose;
functionally unrelated; and
associated with different SIC code.

3. A method as in claim 2, wherein the plurality of industries are each a vertical industry.

4. A method as in claim 1, wherein the common business functions are associated with a particular category of application software useable in said plurality of industries.

5. A method as in claim 1, wherein the technology platform is structured and configured such that transformation into the application software is independent of alteration of software at a source code level by the user.

6. The method as in claim 1 wherein said identifying step comprises at least one of the steps of:
obtaining a listing of industry sectors;
obtaining a listing of existing vertical software applications corresponding to said listing of industry sectors;
storing said listing of industry sectors and said listing of existing vertical software applications in a relational database;
mapping said listing of existing vertical software application to said listing of industry sectors such that corresponding groups of industry sectors and vertical software applications exist in said relational database;
abstracting industry specific concepts from said listing of vertical software applications;
identifying core functional elements from said industry specific concepts;
assigning terms to said functional elements;
sorting said terms by common function; and
identifying common cross vertical business functions.

7. A method for facilitating creating different software applications for a plurality of industries, each software application functionally customized to a specific industry, said method comprising the steps of:
identifying common business functions applicable to the plurality of industries;
developing a software based technology platform including said common business functions;
acquiring a plurality sets of business rules data, each set specific to a different industry;
inputting the plurality sets of business rules data to the technology platform;
wherein said technology platform is structured and configured to receive said plurality sets of business rules data and integrate said business rules data with the technology platform in a manner to transform the technology platform and business rules data into a plurality of customized application software without altering software of said technology platform by a user.

8. A method as in claim 7, wherein the technology platform is structured and configured such that transformation into the application software is independent of alteration of software at a source code level by the user.

9. A method as in claim 7, wherein the plurality sets of business rules data are acquired from at least one of:
application software user;
application software developer;
subject matter expert; and
content provider.

10. A system for creating customized application software specific to a given industry, comprising:
a software based technology platform that comprises common business functions applicable to a plurality of industries;
means for inputting data to the technology platform, said data including business rules specific to said given industry;
wherein the technology platform further comprising means for receiving said data and integrating said data with the technology platform to transform the technology platform and said date into a customized application software without altering software of said technology platform by a user.

11. A method as in claim 10, wherein the technology platform is structured and configured such that transformation into the application software is independent of alteration of software at a source code level by the user.
